(19) United States
(12) Patent Application Publication
(10) Pub. No.: US 2022/0041017 A1
(43) Pub. Date: Feb. 10, 2022

(54) PNEUMATIC TIRE

(71) Applicant: The Yokohama Rubber Co., LTD., Tokyo (JP)

(72) Inventors: Hiroki FUJIMORI, Kanagawa (JP); Shinya HARIKAE, Kanagawa (JP)

(21) Appl. No.: 17/310,682

(22) PCT Filed: Dec. 12, 2019
(86) PCT No.: PCT/JP2019/048775

§ 371 Date: Aug. 17, 2021

(30) Foreign Application Priority Data
Feb. 22, 2019 (JP) 2019-030872

(51) Int. Cl. B60C 9/00; B60C 9/18; B60C 9/20

(52) U.S. Cl. CPC B60C 9/0042; B60C 9/0064; B60C 9/1821; B60C 2009/2093; B60C 2009/0071; B60C 2009/2077; B60C 9/20

(57) ABSTRACT

Provided is a pneumatic tire that includes a belt reinforcing layer formed of an organic fiber cord. A belt layer disposed on an outer circumferential side of a carcass layer in a tread portion is formed of monofilament wires having a wire diameter of 0.30 mm or more and 0.45 mm or less. The belt reinforcing layer is disposed on an outer circumferential side of the belt layer, is formed of an organic fiber cord that is made of a polyethylene terephthalate fiber and has an intermediate elongation under 2.0 cN/dtex load of from 2.0% to 4.0%.

### TECHNICAL FIELD

The present technology relates to a pneumatic tire provided with a belt reinforcing layer formed of an organic fiber cord and particularly relates to a pneumatic tire that can improve steering stability under normal travel conditions and during circuit running while maintaining durability.

### BACKGROUND ART

In pneumatic tires, a carcass layer is mounted between a pair of bead portions, a plurality of belt layers are disposed on an outer circumferential side of the carcass layer in a tread portion, and a belt reinforcing layer including a plurality of organic fiber cords helically wound along a tire circumferential direction is disposed on an outer circumferential side of the belt layers. Such a belt reinforcing layer suppresses rising of a belt end portion at high speeds, and thus, contributes to improved high-speed durability.

Although a nylon fiber cord is mainly used as the organic fiber cord used in such a belt reinforcing layer, using a polyethylene terephthalate fiber cord (hereinafter referred to as a PET fiber cord) that is highly elastic and inexpensive compared to the nylon fiber cord has been proposed (for example, see Japan Unexamined Patent Publication No. 2001-063312). However, the elastic modulus (rigidity) of the PET fiber cord is temperature dependent, and at extremely high speeds such as during circuit running, there is a risk that the elastic modulus (rigidity) may decrease and that steering stability may decline. Therefore, there is a demand for a pneumatic tire provided with a belt reinforcing layer formed of PET fiber cords to improve durability and steering stability under normal travel conditions and during circuit running.

### SUMMARY

The present technology provides a pneumatic tire that is provided with a carcass layer formed of organic fiber cords, the pneumatic tire allowing for improved steering stability under normal travel conditions and during circuit running while maintaining durability.

A pneumatic tire according to an embodiment of the present technology includes: a tread portion extending in a tire circumferential direction and having an annular shape; a pair of sidewall portions disposed on both sides of the tread portion; a pair of bead portions disposed on an inner side of the sidewall portions in a tire radial direction; at least one carcass layer mounted between the pair of bead portions; a plurality of belt layers disposed on an outer circumferential side of the carcass layer in the tread portion; and a belt reinforcing layer disposed on an outer circumferential side of the belt layers. A belt cord that forms the belt layer is formed of a monofilament wire having a wire diameter of 0.30 mm or more and 0.45 mm or less. A belt reinforcing cord that forms the belt reinforcing layer is an organic fiber cord formed of a polyethylene terephthalate fiber. An intermediate elongation under 2.0 cN/dtex load of the belt reinforcing cord is from 2.0% to 4.0%.

In an embodiment of the present technology, as described above, an organic fiber cord formed of a highly rigid polyethylene terephthalate fiber (PET fiber) having an elongation under 2.0 cN/dtex load of from 2.0% to 4.0% is used in the belt reinforcing layer to improve steering stability under normal travel conditions. Additionally, the belt reinforcing layer can effectively suppress rising of a belt end portion at high speeds and thus improve high-speed durability. On the other hand, a monofilament wire is used in the belt layer to suppress elongation of the belt cord and to make the belt layer thinner, and thus, heat build-up can be suppressed even at extremely high speeds such as during circuit running. Accordingly, a reduction in the elastic modulus (rigidity) of the belt reinforcing layer (PET fiber cord) can be prevented, and steering stability at extremely high speeds can be favorably ensured.

In an embodiment of the present technology, the wire diameter of the monofilament wire is preferably 0.33 mm or more and 0.40 mm or less. This ensures durability of the monofilament wire itself, and advantageously maintains the durability while improving steering stability under normal travel conditions and during circuit running.

### BRIEF DESCRIPTION OF DRAWINGS

FIG. 1 is a meridian cross-sectional view illustrating a pneumatic radial tire according to an embodiment of the present technology.

FIGS. 2A-2B are explanatory diagrams schematically illustrating a disposition of a belt layer (monofilament wires).

### DETAILED DESCRIPTION

Configurations of embodiments of the present technology will be described in detail below with reference to the accompanying drawings.

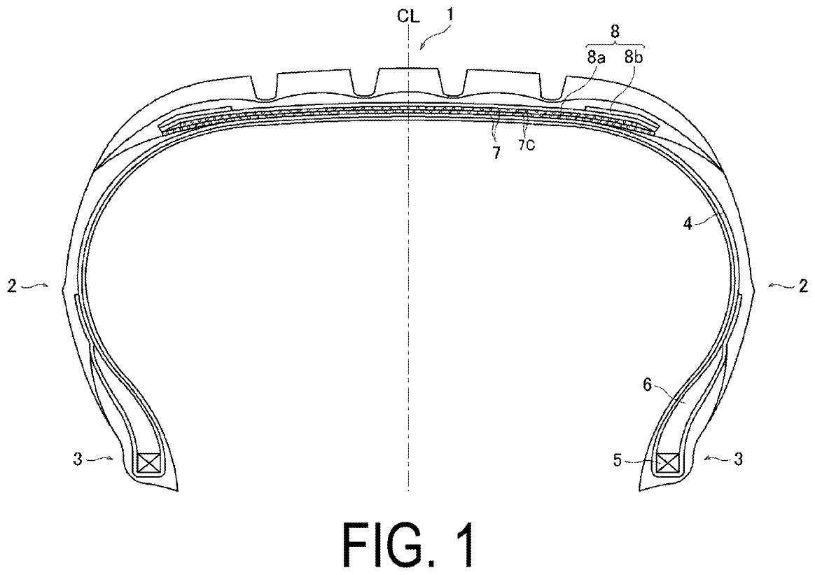

As illustrated in FIG. 1, a pneumatic tire of an embodiment of the present technology includes a tread portion 1, a pair of sidewall portions 2 disposed on both sides of the tread portion 1, and a pair of bead portions 3 disposed in the sidewall portions 2 at an inner side in a tire radial direction. Note that “CL” in FIG. 1 denotes a tire equator. Although not illustrated in FIG. 1 as FIG. 1 is a meridian cross-sectional view, the tread portion 1, the sidewall portions 2, and the bead portions 3 each extend in a tire circumferential direction to form an annular shape. Thus, a toroidal basic structure of the pneumatic tire is configured. Although the description using FIG. 1 is basically based on the illustrated meridian cross-sectional shape, all of the tire components each extend in the tire circumferential direction and form the annular shape.

In the illustrated example, a plurality of main grooves (four main grooves in the illustrated example) extending in the tire circumferential direction are formed in the outer surface of the tread portion 1; however, the number of main grooves is not particularly limited. Further, in addition to the main grooves, various grooves and sipes that include lug grooves extending in a tire width direction can be formed.

A carcass layer 4 including a plurality of reinforcing cords (carcass cords) extending in the tire radial direction is mounted between the pair of bead portions 3 on the right and left. A bead core 5 is embedded within each of the bead portions, and a bead filler 6 having an approximately triangular cross-sectional shape is disposed on an outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through each of the sidewall portions 2 to each of the bead portions 3) and a folded back portion (a portion folded back around the bead core 5 of each bead portion 3 to extend toward each sidewall portion 2) of the carcass layer 4.

A plurality (in the illustrated example, two layers) of belt layers 7 are embedded on an outer circumferential side of the carcass layer 4 in the tread portion 1. Each of the belt layers 7 includes a plurality of reinforcing cords (belt cords) inclining with respect to the tire circumferential direction, with the belt cords of the layers intersecting each other. In the belt layers 7, an inclination angle of the belt cord with respect to the tire circumferential direction is set within a range of, for example, from 10° to 40°. Examples of the belt cord include a steel cord.

A belt reinforcing layer 8 is provided on an outer circumferential side of the belt layer 7 for the purpose of improving high-speed durability and reducing road noise. The belt reinforcing layer 8 includes a reinforcing cord (belt reinforcing cord) oriented in the tire circumferential direction. In the belt reinforcing layer 8, an angle of the belt reinforcing cord with respect to the tire circumferential direction is set within, for example, from 0° to 5°. In an embodiment of the present technology, the belt reinforcing layer 8 necessarily includes a full cover layer 8a that completely covers the belt layers 7, and may include a pair of edge cover layers 8b that locally cover both end portions of the belt layers 7 (the illustrated example includes both the full cover layer 8a and the edge cover layers 8b). Preferably, the belt reinforcing layer 8 is configured such that a strip material made of at least one belt reinforcing cord bunched and covered with coating rubber is wound helically in the tire circumferential direction, and has a jointless structure, in particular.

Since the present technology relates to the belt cord forming the belt layer 7 and the belt cord forming the belt reinforcing layer 8, the basic overall structure of the tire is not limited to that described above.

In the present technology, the belt cord forming the belt layer 7 is not a twisted cord formed by twisting a plurality of strands together, but is formed of a monofilament wire. A wire diameter of the monofilament wire is 0.30 mm or more, and preferably 0.33 mm or more. Accordingly, the monofilament wire in the belt layer 7 can suppress elongation of the belt cord and make the belt layer 7 thinner, and can thus suppress heat build-up even at extremely high speeds such as during circuit running. Note that from a perspective of making the belt layer 7 thinner, a wire diameter of the monofilament wire is 0.45 mm or less, and preferably 0.40 mm or less.

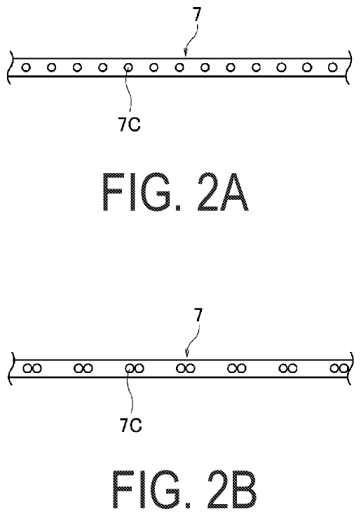

When forming the belt layer 7 with the monofilament wires, as illustrated in FIG. 2A, the monofilament wires may be disposed at intervals one by one, or, as illustrated in FIG. 2B, a plurality of the monofilament wires (two in the drawing) may be bunched with each other at intervals. In the latter case, an interval between the monofilament wires (an interval between the plurality of the monofilament wires that are bunched with each other) is preferably set within, for example, from 0.30 mm to 1.80 mm.

The specific structure of the monofilament wire is not particularly limited as long as the monofilament wire satisfies the wire diameter described above. Various types of monofilament wires that can be used in pneumatic tires can be adopted, including a monofilament wire that is twisted around a wire axis (twisted monofilament), a monofilament wire having a flat cross-sectional shape (flat monofilament), a monofilament wire formed in a helical shape (spiral monofilament), and a monofilament wire formed in a wavy planar shape (2-dimensional wavy monofilament).

When a product of a unit mass (g/m) of the monofilament wire and a wire count of the monofilament wires per 50 mm width (wires/50 mm) in a direction orthogonal to a longitudinal direction of the monofilament wire is defined as an amount of wire, the amount of wire is preferably within a range of from 50 to 280. Such a favorable structure of the belt layer 7 is advantageous in improving steering stability while maintaining durability. When the amount of wire is less than 50, a proportion of the monofilament wires in the belt layer 7 is so small that steering stability may decline. When the amount of wire exceeds 280, there is a risk that belt separation may occur.

In an embodiment of the present technology, a polyester fiber cord having an elongation under 2.0 cN/dtex load of from 2.0% to 4.0%, or preferably from 2.6% to 3.4%, is used as the belt reinforcing cord forming the belt reinforcing layer 8. Examples of the polyester fiber can include a polyethylene terephthalate fiber (PET fiber). Note that in an embodiment of the present technology, the elongation under 2.0 cN/dtex load is an elongation ratio (%) of a sample cord, which is measured under 2.0 cN/dtex load by conducting a tensile test in accordance with JIS (Japanese Industrial Standard)-L1017 “Test Methods for chemical fiber tire cords” and under the conditions that a length of specimen between grips be 250 mm and a tensile speed be 300±20 mm/minute.

Thus, the belt layer 7 formed of the monofilament wires of a particular wire diameter and the belt reinforcing layer 8 formed of the organic fiber cord having the specific physical properties can be used in combination in a pneumatic tire according to an embodiment of the present technology to improve steering stability under normal travel conditions and during circuit running while maintaining durability. That is, in the belt reinforcing layer 8, the polyethylene terephthalate fiber (PET fiber) having the physical properties described above including high rigidity can be used to improve steering stability under normal travel conditions. Additionally, the belt reinforcing layer 8 effectively suppresses the rising of the belt end portion at high speeds, and thus, can improve high-speed durability. On the other hand, in the belt layer, the monofilament wire described above can be used to suppress the elongation of the belt cord and to make the belt layer 7 thinner, thus suppressing heat build-up even at extremely high speeds such as during circuit running. Accordingly, a reduction in the elastic modulus (rigidity) of the belt reinforcing layer 8 (PET fiber cord) can be prevented, and steering stability at extremely high speeds can be favorably ensured.

Here, in a configuration in which the twisted cord is used, instead of the monofilament wire, as the belt cord that forms the belt layer 7, elongation can be caused in the belt cord by the twisted structure, and the belt 7 cannot be made thinner, and thus, the effects described above cannot be obtained. When the wire diameter of the monofilament wire is less than 0.30 mm, the monofilament wire is too thin to ensure sufficient durability of the wire itself. When the wire diameter of the monofilament wire exceeds 0.45 mm, the belt layer 7 cannot be made sufficiently thinner than when using a conventional twisted cord. When the elongation under 2.0 cN/dtex load of the organic fiber cord forming the belt reinforcing layer 8 is less than 2.0%, the rigidity of the organic fiber cord is so high that durability against separation decreases. When the elongation under 2.0 cN/dtex load of the organic fiber cord forming the belt reinforcing layer 8 exceeds 4.0%, the rigidity of the belt reinforcing layer 8 is too low to obtain good steering stability.

In order to obtain the belt reinforcing cord (PET fiber cord) having the physical properties described above, dip processing may be optimized, for example. In other words, before a calendar process, dip processing with an adhesive is performed on the belt reinforcing cord (PET fiber cord); however, preferably, in a normalizing process after a two-bath treatment, an ambient temperature is set within a range of from 210° C. to 250° C. and a cord tension is set within a range of 2.2×10-² N/tex to 6.7×10-² N/tex. Accordingly, the desired physical properties as described above can be imparted to the belt reinforcing cord (PET fiber cord). When the cord tension in the normalizing process is smaller than 2.2×10-² N/tex, cord elastic modulus decreases, and steering stability declines. In contrast, when the cord tension is greater than 6.7×10-² N/tex, cord elastic modulus increases, and thus separation is likely to happen.

### Examples

Tires of Conventional Example 1, Comparative Examples 1 to 3, and Examples 1 to 5 were manufactured. The tires had a tire size of 235/40R18, had the basic structure illustrated in FIG. 1, and varied, as indicated in Table 1, in the structure of a steel cord forming the belt layer, the wire diameter (cord diameter), the type of organic fiber used in the organic fiber cord forming the belt reinforcing layer, and the elongation under 2.0 cN/dtex load of the organic fiber cord.

In each of the examples, the belt reinforcing layer has a jointless structure in which a strip made of at least one organic fiber cord (nylon 66 fiber cord or PET fiber cord) bunched and covered with coating rubber is wound helically in the tire circumferential direction. The cord count density in the strip is 50 cords/50 mm. In addition, the organic fiber cord (nylon 66 fiber cord or PET fiber cord) has a structure of 1400 dtex/2 in Conventional Example 1 and Comparative Example 2 and a structure of 1100 dtex/2 in the other examples.

In the column of the “type of organic fiber” in Table 1, the nylon 66 fiber cord is indicated as “N66” and the PET fiber cord is indicated as “PET”.

The test tires were evaluated, according to the following evaluation method, for steering stability under normal travel conditions, steering stability during circuit running, and tire durability, and the results are also shown in Table 1.

### Steering Stability (Under Normal Travel Conditions, During Circuit Running)

The test tires were assembled on wheels having a rim size of 18×8 J, mounted on a test vehicle (engine displacement 3000 cc), and inflated to an air pressure of 230 kPa. Sensory evaluation was performed by five test drivers on a test course with a paved road for steering stability under two conditions: a speed of from 30 km/h to 100 km/h (under normal travel conditions) and a speed of from 100 km/h to 270 km/h (during circuit running). The evaluation results were scored by a 5-point method with the results of Conventional Example 1 being assigned the value of 3 points (reference), and an average value of the scores of the five test drivers was indicated. Larger values indicate superior steering stability.

### Tire Durability

The test tires were mounted on wheels having a rim size of 18×8 J and inflated to an internal pressure of 230 kPa. The tires were held for two weeks in a chamber maintained at a chamber temperature of 60° C., and then oxygen inside the chamber was released, and the chamber was filled with air to an internal pressure of 160 kPa. A drum testing machine having a smooth drum surface formed of steel and having a diameter of 1707 mm was used to run the pre-treated test tires 5000 km for 100 hours under fluctuating conditions including an ambient temperature of 38±3° C., a running speed of 50 km/hr, a slip angle of 0±3°, and a maximum load of 70±40%, with the load and the slip angle fluctuated by a rectangular wave of 0.083 Hz. After the running, the tires were cut open, and a separation length in a width direction was measured at an end portion of the belt in a belt width direction. Evaluation results are expressed as index values with the inverse of the measurement value in Conventional Example 1 being assigned as 100. Larger index values indicate a smaller separation length and more excellent durability against belt-edge-separation. An index value that is “98” or more indicates that a conventional level of good durability was maintained.

TABLE 1-1

| | | | Conventional | Comparative | Comparative |
|---|---|---|---|---|---|
| | | | Example 1 | Example 1 | Example 2 |
| Belt layer | Belt cord | | Twisted | Twisted | Monofilament |
| | structure | | cord | cord | wire |
| | | | 2 + 2 × 0.25 | 2 + 2 × 0.25 | |
| | Wire | mm | 0.65 | 0.65 | 0.30 |
| | diameter | | | | |
| | (cord | | | | |
| | diameter) | | | | |
| Belt | Type of organic | | N66 | PET | N66 |
| reinforcing | fiber | | | | |
| layer | Elongation | % | 7.0 | 3.0 | 7.0 |
| | under 2.0 | | | | |
| | cN/dtex | | | | |
| | load | | | | |
| Steering stability (under | | | 3.0 | 3.2 | 3.0 |
| normal travel conditions) | | | | | |
| Steering stability (during | | | 3.0 | 2.8 | 3.0 |
| circuit running) | | | | | |
| Tire durability | | Index | 100 | 100 | 98 |
| | | value | | | |

TABLE 1-2

| | | | | | Comparative |
|---|---|---|---|---|---|
| | | | Example 1 | Example 2 | Example 3 |
| Belt layer | Belt cord structure | | Mono- | Mono- | Mono- |
| | | | filament | filament | filament |
| | | | wire | wire | wire |
| | Wire | mm | 0.30 | 0.35 | 0.28 |
| | diameter | | | | |
| | (cord | | | | |
| | diameter) | | | | |
| | Type of organic | | PET | PET | PET |
| | fiber | | | | |
| Belt | Elongation | % | 3.0 | 3.0 | 3.0 |
| reinforcing | under 2.0 | | | | |
| layer | cN/dtex load | | | | |
| Steering stability (under | | | 3.6 | 3.6 | 3.4 |
| normal travel conditions) | | | | | |
| Steering stability (during | | | 3.6 | 3.4 | 3.6 |
| circuit running) | | | | | |
| Tire durability | | Index | 98 | 100 | 90 |
| | | value | | | |

TABLE 1-3

| | | | Example 3 | Example 4 | Example 5 |
|---|---|---|---|---|---|
| Belt layer | Belt cord structure | | Mono- | Mono- | Mono- |
| | | | filament | filament | filament |
| | | | wire | wire | wire |
| | Wire | mm | 0.45 | 0.30 | 0.30 |
| | diameter | | | | |
| | (cord | | | | |
| | diameter) | | | | |
| Belt | Type of organic | | PET | PET | PET |
| reinforcing | fiber | | | | |
| layer | Elongation | % | 3.0 | 2.0 | 4.0 |
| | under 2.0 | | | | |
| | cN/dtex load | | | | |
| Steering stability (under | | | 3.6 | 3.4 | 3.2 |
| normal travel conditions) | | | | | |
| Steering stability (during | | | 3.2 | 3.4 | 3.0 |
| circuit running) | | | | | |
| Tire durability | | Index | 97 | 96 | 97 |
| | | value | | | |

As can be seen from Table 1, the tires of Examples 1 to 5, in comparison to that of Conventional Example 1 as the reference, provide improved steering stability under normal travel conditions and steering stability during circuit running in a highly compatible manner while maintaining tire durability. On the other hand, in Comparative Example 1, the twisted cord was used as the belt cord, and thus, steering stability decreased during circuit running. In Comparative Example 2, the organic fiber cord that forms the belt reinforcing layer was formed of nylon 66, the intermediate elongation under 2.0 cN/dtex load was large, and thus, the effect of improving steering stability under normal travel conditions and steering stability during circuit running was not obtained. In Comparative Example 3, the wire diameter of the monofilament wire was so small that tire durability decreased.

1. A pneumatic tire, comprising:
a tread portion extending in a tire circumferential direction and having an annular shape;
a pair of sidewall portions disposed on both sides of the tread portion;
a pair of bead portions disposed on an inner side of the sidewall portions in a tire radial direction;
at least one carcass layer mounted between the pair of bead portions;
a plurality of belt layers disposed on an outer circumferential side of the carcass layer in the tread portion; and
a belt reinforcing layer disposed on an outer circumferential side of the belt layers,
the belt layers being formed of belt cords that are monofilament wires having a wire diameter of 0.30 mm or more and 0.45 mm or less,
the belt reinforcing layer being formed of a belt reinforcing cord that is an organic fiber cord made of a polyethylene terephthalate fiber, the belt reinforcing cord having an intermediate elongation under 2.0 cN/dtex load of from 2.0% to 4.0%.

2. The pneumatic tire according to claim 1, wherein the wire diameter of the monofilament wire is 0.33 mm or more and 0.40 mm or less.
